(19) United States
(12) Patent Application Publication
(10) Pub. No.: US 2026/0296104 A1
(43) Pub. Date: Oct. 1, 2026

(54) Tire Comprising a Sidewall with at Least One High-Contrast Sidewall Element

(71) Applicant: COMPAGNIE GENERALE DES ETABLISSEMENTS MICHELIN, Clermont-Ferrand (FR)

(72) Inventors: Olivier MUHLHOFF, Clermont-Ferrand Cedex 9 (FR); Aline RIOU, Clermont-Ferrand Cedex 9 (FR); Sylvain MAYER, Clermont-Ferrand Cedex 9 (FR)

(21) Appl. No.: 19/480,819

(22) PCT Filed: Apr. 26, 2024
(86) PCT No.: PCT/EP2024/061620

§ 371 Date: Nov. 2, 2025

(30) Foreign Application Priority Data
May 3, 2023 (FR) FR2304436

(51) Int. Cl. B60C 1/00; B60C 13/00; C08K 3/04; C08K 3/06; C08K 3/22; C08K 5/01; C08K 5/18; C08K 5/3437; C08K 5/44; C08L 7/00

(52) U.S. Cl. CPC B60C 1/0025; B60C 13/001; C08K 3/04; C08K 3/06; C08K 3/22; C08K 5/01; C08K 5/18; C08K 5/3437; C08K 5/44; C08L 7/00; C08K 2003/2296; C08L 2205/02; C08L 2207/322

(57) ABSTRACT

A tire (1) for a vehicle, having at least one sidewall (2) with at least one high-contrast sidewall element (3) constituted by a texture having a first brightness L*1 at least equal to 1 and at most equal to 15, any adjacent sidewall surface portion (21) having a second brightness L*2 at least equal to L*1+5. A rubber composition of the sidewall (2) is disclosed which has a good compromise between the reduction of blooming and the resistance to attack by ozone. The elastomer matrix has an isoprene elastomer with a content of at least 35 phr, and at the most 65 phr, and a butadiene elastomer with a content of at least 35 phr, and at the most 65 phr, the content of reinforcing filler is at least 5 phr, and at the most 70 phr, the content of anti-ozone wax is at least 1.2 phr, and at the most 2.8 phr, and the content of crumb rubber is at least

The present invention concerns a tire for a vehicle, comprising a sidewall with at least one high-contrast sidewall element.

A tire comprises two sidewalls, with a sidewall being the portion of tire which connects an end of the tread, which is designed to come into contact with the ground, to a bead, which is designed to be fitted on a rim.

Hereinafter, the outer surface of a sidewall, in contact with the atmospheric air, is designated more simply by the term “sidewall surface”. A sidewall surface generally comprises at least one graphic element, and/or, optionally, an aesthetic element. A graphic element, which is conventionally known as marking and comprises letters, numbers or symbols, is generally designed to communicate technical, commercial or legal information.

By definition, a high-contrast sidewall element designates a sidewall surface element, constituted by a specific texture which is different from that of the sidewall surface, which is most often smooth. This texture gives the said high-contrast sidewall element a more somber appearance than that of any sidewall surface portion which is adjacent to the said high-contrast sidewall element, such that this high-contrast sidewall element can be visually distinguished from any other adjacent sidewall surface portion. The subject of a high-contrast sidewall element can be either a graphic element or an aesthetic element, or a sidewall surface portion which surrounds the said graphic or aesthetic element, thus making the said graphic or aesthetic element particularly visible on the sidewall surface.

Thus, whether it is to enhance sidewall surface graphic elements or aesthetic elements, a constant concern of tire designers is to produce high-contrast sidewall elements.

The contrast between a high-contrast sidewall element and a sidewall surface portion adjacent to the said high-contrast sidewall element is due to a difference of brightness between the two areas. An adjacent portion of surface, which can be smooth, or can be provided with a different texture, has brightness greater than that of the texture of the said high-contrast sidewall element, i.e. it appears to be visually lighter. This texture is constituted by a rubbery material, also known as a rubber composition or elastomer composition, identical to that of the sidewall portion which is in contact with the atmospheric air, since this texture is integral with the sidewall.

The brightness can be quantified by the brightness luminance, expressed in candela/m², which measures the flow of light coming from a lit surface reflected in the eye of the observer. However, the ratio between the luminance and the visual perception of the brightness is not linear, and is complex. This is why, from a practical point of view, the International Commission on Illumination (CIE) has defined brightness L* as a parameter which characterises the capacity of a surface to reflect light, from the brightness of the light produced by a primary or secondary source, expressed in candelas per square metre (cd/m²), relative to the brightness of the white taken as a reference. Thus, hereinafter, the brightness L* is expressed is expressed according to a scale going from 0 to 100 in accordance with the L*a*b* colour model adopted in 1976 by the International Commission on Illumination. The value 100 represents white or total reflection and the value 0 represents black or total absorption.

In order to calculate the difference between a first brightness L*1 of the texture of the high-contrast sidewall element and a second brightness L*2 of an adjacent sidewall surface portion, it is necessary to measure respectively the first brightness L*1 and the second brightness L*2 by means of a spectro-colorimeter, for example a CM 700D spectro-colorimeter by KONICA-MINOLTA. In order to measure the first brightness L*1 of the texture, the spectro-colorimeter is positioned on the texture, and this measurement is carried out with the SCI (Specular Component Included) mode, parameterised at an angle of 8°, and with regulation of the light of type D65 (regulation defined according to the CIE). Similarly, in order to measure the second brightness L*2 of an adjacent sidewall surface portion, the spectro-colorimeter is positioned on the said sidewall surface portion. In order to improve the determination of this second brightness L*2, it is possible to carry out a plurality of measurements of brightness on a plurality of adjacent sidewall surface portions, then to deduce associated average brightness therefrom.

High-contrast sidewall elements, having a difference in brightness substantially less than that of an adjacent sidewall surface portion, have been described in the documents WO 2016005572 A1 and WO 2011036061 A1 and WO 20174919 A1.

On tire sidewall surfaces comprising high-contrast sidewall elements, it has been found that the contrast between the high-contrast sidewall elements and any adjacent sidewall surface portion changes over time.

The development of the contrast over a period of time results in both the development of the texture and that of the visual appearance of the sidewall surface.

The development of the texture can be derived from it being dirtied, abraded at least partly, or ageing of its component material.

The development of the visual appearance of the sidewall surface typically results in development, at least locally, of its colouring (blue staining, development to a dark brown colour, appearance of whitish spots), development of its brightness (duller appearance), or the appearance of surface scratches or cracking.

More globally, the ageing of the sidewall surface is associated with the elastomer nature of its material. In a known manner, conventional rubber compositions comprise diene, natural or synthetic elastomers, the molecular chains of which have double carbon-carbon bonds. These double bonds are chemically more reactive than a single carbon-carbon bond and are therefore likely to deteriorate more or less rapidly after prolonged exposure to the atmosphere, owing to known mechanisms of oxidation and ozonolysis. The action of the ozone assists the appearance of cracking on the surface of the sidewall. These deterioration mechanisms are further accelerated by the action of heat (thermo-oxidation), or by that of light (photo-oxidation).

In order to counter the chemical deterioration of the rubber composition by ozone, it is known to use anti-ozone agents, such as, for example, anti-ozone waxes. These anti-ozone waxes provide protection under static conditions via the formation of a protective surface coating. However, these anti-ozone waxes are characterised by their aptitude for migrating as far as the sidewall surface and crystallising, which modifies the visual appearance of the sidewall surface, by giving rise to the appearance of spots or by giving the sidewall a dull grey appearance, or also by giving rise to lighter colouring of the sidewall. This phenomenon is known as blooming. This phenomenon also causes non-homogeneous colouring, and makes the sidewall surface, which is initially dark and shiny, grey and dull.

Thus, non-homogeneous colouring of the sidewall surface decreases the effect of contrast of the high-contrast element, and detracts from the visual and aesthetic appearance of the sidewall.

In order to obtain a long lasting high-contrast sidewall element during the life of the tire, it is thus necessary to be able to reduce, or eliminate, the deterioration of the colour and/or of the shine of the tire sidewall surface, while providing it with good capacity to withstand ozone attacks which give rise to cracking on the sidewall surface.

Increasing the life of the contrast is in fact an important commercial factor for tire manufacturers. Thus, for example, when a user replaces only the tires which are fitted on the front of his vehicle, he may find there is a significant difference between the contrast observed on the new tires fitted at the front of the vehicle, and that observed on the worn tires fitted at the rear of the vehicle. This difference of contrast between the front and rear tires can be considered unacceptable by the user, in particular when his vehicle is a sports or prestige vehicle.

For a tire comprising a sidewall with at least one high-contrast sidewall element, the inventors have given themselves the objective of increasing the durability over a period of time of the contrast between the said high-contrast sidewall element and the adjacent sidewall surface portion, by means of an appropriate rubber composition of the sidewall, in particular in the vicinity of the sidewall surface.

This objective has been achieved by a tire for a vehicle, comprising a sidewall with at least one high-contrast sidewall element:
the high-contrast sidewall element being constituted by a texture having a first brightness L*1 at least equal to 1 and at most equal to 15,
any sidewall surface portion adjacent to the high-contrast sidewall element having a second brightness L*2 at least equal to L*1+5,
the first and second brightnesses (L*1, L*2) being expressed on a scale ranging from 0 to 100 in accordance with the L*a*b colour model adopted in 1976 by the International Commission on Illumination,
the sidewall comprising a rubber composition based on an elastomer matrix, at least one reinforcing filler, at least one cross-linking system, at least one plasticising agent, at least one anti-ozone wax, and at least one crumb rubber,
the elastomer matrix comprising an isoprene elastomer with a content of at least 35 phr and at the most 65 phr and a butadiene elastomer with a content of at least 35 phr, and at the most 65 phr,
the content of reinforcing filler being at least 5 phr, and at the most 70 phr,
the content of anti-ozone wax being at least 1.2 phr, and at the most 2.8 phr,
and the content of crumb rubber being at least 2 phr, and at the most 30 phr.

According to the invention, the high-contrast sidewall element is constituted by a texture having a first brightness L*1 at least equal to 1 and at most equal to 15.

The lower the brightness of the high-contrast sidewall element when the tire is new, the greater the contrast for a given brightness of an adjacent sidewall surface portion, and the more this contrast will remain significant, over time, on the aged tire. In fact, over a period of time, this first brightness L*1 of the texture of the high-contrast sidewall element tends to increase, for example because of dust, dirt, and ageing of the material. In addition, in this brightness range, there is good contrast with any adjacent sidewall surface portion, which, in conventional tire designs, has brightness which is most often between 24 and 28. It should be noted that a texture with a first brightness L*1, which is typically at least 9, is easier to produce, but the contrast is low.

According to the invention, any sidewall surface portion adjacent to the high-contrast sidewall element has a second brightness L*2 at least equal to L*1+5.

The greater the difference in brightness between the high-contrast sidewall element and any adjacent sidewall surface portion, the greater the contrast. The greater the difference of brightness is on the new tire, the more it will remain significant over a period of time on the aged tire.

Again according to the invention, the sidewall comprises a rubber composition based on an elastomer matrix, at least one reinforcing filler, at least one cross-linking system, at least one plasticising agent, at least one anti-ozone wax, and at least one crumb rubber.

The expression “rubber composition based on” means a rubber composition comprising the reaction mixture and/or product in situ of the different components used, some of these components being able to react, and/or being designed to react with one another, at least partly, during different production phases of the rubber composition, with the rubber composition thus being able to be in the totally or partly cross-linked state, or in the non-cross-linked state.

A rubber composition comprises at least one, and often a plurality of elastomers, in particular a plurality of diene elastomers. This mixture of elastomers, in particular diene, is known as the elastomer matrix. Preferably, the elastomer matrix comprises at least two different diene elastomers.

“Elastomer” means a polymer, i.e. a homopolymer or a copolymer, having resilient properties obtained after cross-linking. The term rubber is a common synonym for elastomer.

“Diene elastomer”, or equally well “diene rubber”, whether natural or synthetic, means an elastomer constituted at least partly by diene monomer units (monomers which bear two double carbon-carbon bonds, which are or are not conjugated). Diene elastomers are non-thermoplastic.

The diene elastomers can be classified into two categories, i.e. “substantially unsaturated” diene elastomers and “substantially saturated” diene elastomers. A “substantially unsaturated” diene elastomer is a diene elastomer obtained at least partly from conjugated diene monomers, having a content of patterns or units of diene origin (conjugated dienes) which is greater than 15% (mol %). Thus, diene elastomers such as butyl rubbers or copolymers of dienes and alpha-olefins of the EPDM type are not included in the preceding definition, and can in particular be classified as “substantially saturated” diene elastomers (low or very low content of patterns of diene origin, always less than 15%).

In particular, diene elastomer which can be used in the rubber compositions according to the invention means:
a) Any homopolymer of a diene monomer, whether conjugated or not, having from 4 to 18 carbon atoms;
b) Any copolymer of a diene, whether conjugated or not, having from 4 to 18 carbon atoms and at least one other monomer, the other being able to be ethylene, an olefin or a diene, whether conjugated or not.

Appropriate conjugated dienes are conjugated dienes having from 4 to 12 carbon atoms, in particular 1,3-dienes, such as, in particular, 1,3-butadiene and isoprene.

Appropriate non-conjugated dienes are non-conjugated dienes having from 6 to 12 carbon atoms, such as 1,4-hexadiene, norbornene ethylidene, dicyclopentadiene.

Appropriate olefins are vinyl aromatic compounds having from 8 to 20 carbon atoms and α-aliphatic mono-olefins having from 3 to 12 carbon atoms.

Appropriate vinyl aromatic compounds are for example styrene, ortho-, meta-, para-methylstyrene, the commercial “vinyl-toluene” mixture, para-tertiobutylstirene.

Appropriate α-aliphatic mono-olefins are in particular α-acyclical aliphatic mono-olefins having from 3 to 18 carbon atoms.

More particularly, the diene elastomer is:
(a′) Any homopolymer of a conjugated diene monomer, in particular any homopolymer obtained by polymerisation of a conjugated diene monomer having from 4 to 12 carbon atoms;
(b′) Any copolymer obtained by copolymerisation of one or a plurality of conjugated dienes with one another or with one or a plurality of vinyl aromatic compounds having from 8 to 20 carbon atoms;
(c′) Any copolymer obtained by copolymerisation of one or a plurality of dienes, whether conjugated or not, with ethylene, an α-mono-olefin or their mixture, such as, for example, elastomers obtained from ethylene, propylene with a non-conjugated diene monomer of the aforementioned type.

A reinforcing filler, which is designed to reinforce a rubber composition, can be an organic filler such as carbon black, or an inorganic filler such as silica or alumina in combination with a bonding agent between the inorganic filler and the diene elastomer, or also a mixture of these types of fillers.

The cross-linking system can be any type of system known to persons skilled in the art in the domain of rubber compositions for tires. In particular, it can be based on sulphur, and/or peroxide and/or bismaleimides Preferably, the cross-linking system is based on sulphur reference is then made to a curing system. The sulphur can be added in any form, in particular in the form of molecular sulphur or a sulphur donor agent. At least one curing accelerator is also preferably present, and, optionally, preferably also, it is possible to use various known curing activators such as zinc oxide, stearic acid, or an equivalent compound such as stearic acid salts and transition metal salts, guanidine derivatives (in particular diphenylguanidine), or also known curing retardants. As an accelerator, use can be made of any compound which can act as an accelerator for curing of diene elastomers in the presence of sulphur, in particular accelerators of the thiazole type as well as their derivatives, accelerators of the type such as sulphonamides, thiurams, dithiocarbamates, dithiophosphates, thioureas and xanthates.

A plasticising agent is an agent conventionally used, known to persons skilled in the art and habitually utilised in rubber compositions. A plasticising agent can be selected from the group constituted by plasticising oils, high vitreous transition temperature plasticising resins Tg, and their combinations.

Any extension oil, whether it is of an aromatic or non-aromatic nature, and is known for its plasticising properties relative to elastomers, can be used. At ambient temperature (23° C.), these oils, which are more or less viscous, are liquids (i.e. as a reminder, substances which have the capacity ultimately to adopt the form of their container), unlike in particular high Tg hydrocarbonated resins, which are by nature solid at ambient temperature. Plasticising oil generally has a vitreous transition temperature Tg which is lower than −20° C., and preferably lower than −40° C. The vitreous transition temperature Tg of the plasticising oil is measured according to the standard ASTM D3418 (2008).

By definition a high Tg hydrocarbonated resin, typically at 30° C. at least, is solid at ambient temperature and pressure (23° C., 1 atm), whereas a plasticising oil is liquid at ambient temperature, and a low Tg hydrocarbonated resin is viscous at ambient temperature. Hydrocarbonated resins, which are also known as hydrocarbonated plasticising resins, are polymers which are well known to persons skilled in the art, substantially based on carbon and hydrogen, but being able to comprise other types of atoms, for example oxygen, which can be used in particular as plasticising or tackifying agents in polymer matrices. They are by nature at least partly miscible (i.e. compatible) with the contents used in the polymer compositions for which they are destined, such as to act as true diluting agents. In a known manner, these hydrocarbonated resins can also be classified as thermoplastic resins in the sense that they soften when heated and can thus be moulded. The vitreous transition temperature Tg of the plasticising resin is measured according to the standard ASTM D3418 (2008).

The anti-ozone waxes concerned can be for example paraffin waxes, microcrystalline waxes, or mixtures of paraffin and microcrystalline waxes. They are constituted by a mixture of linear and non-linear alkanes (iso-alkanes, cycloalkanes, branched alkanes) obtained from petroleum refinery or catalytic hydrogenation of carbon monoxide (Fisher Tropsch process), comprising mostly chains of at least 20 carbon atoms.

The determination of the distribution of the alkanes is carried out by gaseous phase chromatography combined with a flame ionisation detector (“GPC-FID”). The chromatogram is used according to the EWS (“European Wax Federation”) method.

All known anti-ozone waxes may be used, including natural waxes, such as, for example, candelilla wax or carnauba wax. These waxes may, furthermore, be used as blends.

Anti-ozone waxes are commercially available, for example, “Varazon 4959”, “Varazon 6500” and “Varazon 6810” by Sasol, “Ozoace 0355” by Nippon Seiro, “Negozone 9343” by H & R and “H3841” by Yanggu Huatai.

The crumb rubber is the form of granules, optionally made into a sheet of rubber.

Mostly this crumb rubber is obtained from grinding or from micronisation of cured rubber compounds already used for a first application, for example in a tire, soles of shoes, seals. It is thus a product of recycling of these materials.

In a known manner, the crumb rubber can more particularly be obtained by reduction into granules of used tires, from which the reinforcement materials such as steels or textile fibres have been removed.

The crumb rubber can be prepared by cryogenic crushing of used tires, for example according to the process described in document U.S. Pat. No. 7,445,170, comprising successive and independent steps of granulation, separation of the metal and textile reinforcements, cooling and micronisation, in order to obtain a rough distribution of micronic particles of cured mixture (also known as microparticles). This micronisation can be carried out by means of a percussion mill with a conical form such as described in document U.S. Pat. No. 7,861,958. The cryogenised incoming substance penetrates into the mill (for example CUM150 mills made by Netzsch or CW250 made by Alpine can be used), and is then transferred by gravity to a rotor rotating at high speed. The cryogenised incoming substance is thus projected onto the walls of the chamber of the rotor multiple times, leading to its micronisation. The particles may then pass through a series of two vibrating screens of the same size in order to separate the final elements not made of cured mixture. A coarse distribution of micronic particles of cured mixture is obtained. “Microparticles” means particles which have a size, i.e. their diameter, in the case of spherical particles, or their largest dimension, in the case of anisometric particles, of a few tens or hundreds of microns. The size of the microparticles can be determined by techniques known to persons skilled in the art, such as microscopy, for example.

The crumb rubber can be simple shreds or micronisates of rubber, without other treatment. However, it is also known for the crumb rubber to be able to undergo treatment in order to modify it. This treatment can consist of chemical modification of functionalisation or devulcanization. It can also be a thermo-mechanical, thermo-chemical, biological treatment.

According to the invention, the elastomer matrix comprises an isoprene elastomer with a content of at least 35 phr, and at the most 65 phr, and a butadiene elastomer with a content of at least 35 phr, and at the most 65 phr.

“Isoprene elastomer” means, in a known manner, a homopolymer or copolymer of isoprene. In other words an isoprene elastomer can be selected from the group constituted by natural rubber (NR), synthetic polyisoprenes (IRs), the various isoprene copolymers, and the mixtures of these elastomers. Isoprene copolymers include in particular isobutene-isoprene (butyl rubber—IIR), isoprene-styrene (SIR), isoprene-butadiene (BIR) or isoprene-butadiene-styrene (SBIR) copolymers. Preferably, the isoprene elastomer can be selected from the group constituted by natural rubber, synthetic cis-1,4-polyisoprenes, and their combinations. Even more preferentially, the isoprene elastomer is chosen from the group consisting of natural rubber, synthetic polyisoprenes having a content (mol %) of cis-1,4 bonds of greater than 90% (even more preferentially greater than 98%), and combinations thereof.

“Butadiene elastomer” means, in a known manner, a homopolymer or copolymer of butadiene. In other words, a butadiene elastomer can be selected from the group constituted by polybutadienes (BR), the different butadiene copolymers and mixtures of these elastomers. Among the butadiene copolymers, reference will be made in particular to butadiene-styrene (SBR) or ethylene-butadiene (EBR) copolymers. Preferentially, the butadiene elastomer can be a cis-1,4-polybutadiene; in particular a polybutadiene having a content (mol %) of cis-1,4 bonds greater than 90%, more preferentially still greater than 96%.

The unit “pce” or “parts percent of elastomer” represents the part in mass percent of elastomer or rubber. In English this unit takes the form of “phr” (“parts per hundred of rubber”). The elastomers of the crumb rubber are excluded from the elastomer mass in question.

According to the invention, the content of reinforcing filler is at least 5 phr, and at the most 70 phr.

Again according to the invention, the content of anti-ozone wax is at least 1.2 phr, and at the most 2.8 phr.

Also according to the invention, the crumb rubber content is at least 2 phr, and at the most 30 phr.

The inventors have found that the combination of the respective proceeding contents of reinforcing filler, anti-ozone wax and crumb rubber, for an elastomer matrix with the respective contents of isoprene elastomer and butadiene elastomer previously described, make it possible to obtain a satisfactory compromise between the reduction of the bloom and the resistance to attack of the sidewall by ozone.

Advantageously, the content of anti-ozone wax is at least 1.4 phr, and at the most 2.6 phr, and preferably at least 1.6 phr, and at the most 2.4 phr.

Also advantageously, the content of crumb rubber is at least 5 phr, and at the most 20 phr, preferably at least 5.5 phr, and at the most 19.5 phr, more preferably at least 6 phr, and at the most 19 phr, and still more preferably at least 6 phr, and at the most 18 phr.

It should be noticed that, according to the present invention, the crumb rubber is not considered as a reinforcing filler. Consequently, the content of crumb rubber is not included in the content of reinforcing filler.

Advantageously, the crumb rubber has a distribution of sizes of microparticles such that it comprises less than 1% by mass of particles which are not retained by means of a 600 μm screen, and less than 10% by mass of microparticles which are not retained by means of a 105 μm screen, in relation to the total mass of microparticles of the crumb. Preferably, it has a distribution of sizes of microparticles such that it comprises less than 1% by mass of microparticles which are not retained by means of a 600 μm screen, and less than 10% by mass of microparticles which are not retained by means of a 149 μm screen, in relation to the total mass of microparticles of the crumb rubber. More preferably, it has a distribution of sizes of microparticles, such that it comprises less than 1% by mass of microparticles which are not retained by means of a 600 μm screen, and less than 10% by mass of microparticles which are not retained by means of a 177 μm screen, in relation to the total mass of microparticles of the crumb rubber. Even more preferably, it has a distribution of sizes of microparticles, such that it comprises less than 1% by mass of microparticles which are not retained by means of a 400 μm, screen and less than 10% by mass of microparticles which are not retained by means of a 177 μm screen, in relation to the total mass of microparticles of the crumb rubber. The distribution of crumb rubber microparticles is determined according to the standard ASTM D5644-01 (2013).

In order to obtain such a crumb rubber with such distributions, an additional screening step according to a size criterion was carried out. The screening can be carried out by different technologies (vibration, centrifugation, aspiration) known to persons skilled in the art. Preferably, this screening step is carried out using a series of screens stacked in order of size (screens with calibrated mesh sizes such as the commercial products by Gericke, for example). Thus, the larger particles are retained on the screen while the smaller ones pass to the lower stage on the next screen. Persons skilled in the art will understand that the distributions considered below can be composed of all the particles that pass through a given screen, or of all the particles retained between 2 stages.

Also advantageously, the crumb rubber is a crumb rubber which has not been subjected to any modification by a treatment selected from among the group constituted by heat, mechanical, biological and chemical treatments and their combinations.

Also advantageously, the ratio between the content of crumb rubber, expressed in phr, and the content of anti-ozone wax, expressed in phr, is at least 5.50, and at the most 17.00, preferably at least 6.00, and at the most 17.00, and more preferably at least 6.50, and at the most 12.50.

Preferably, the content of reinforcing filler is at least 10 phr, and at the most 60 phr, preferably at least 15 phr, and at the most 55 phr, more preferably at least 15 phr, and at the most 50 phr, and still more preferably at least 15 phr, and at the most 45 phr.

Advantageously, the sum of the content of reinforcing filler and of the content of crumb rubber is at least 30 phr, and at the most 65 phr, preferably at least 30 phr, and at the most 60 phr, and more preferably at least 35 phr, and at the most 50 phr.

Preferably, the reinforcing filler comprises mostly carbon black.

When reference is made to a “predominant” compound, this means, within the meaning of the present invention, that this compound is predominant among the compounds of the same type in the composition, that is to say that it is the one which represents the greatest amount by weight among the compounds of the same type, and preferably more than 50% by weight, more preferably more than 75% by weight. Thus, a “predominant” filler is the one which represents the greatest weight among the fillers of the composition.

Advantageously, the ratio between the content of reinforcing filler, expressed in phr, and the content of plasticising agent, expressed in phr, is at least 1.00, and at the most 5.00, preferably at least 1.50, and at the most 4.50, more preferably at least 2.00, and at the most 4.00, and even more preferably at least 2.00, and at the most 3.50.

When the plasticising agent is a mixture of a hydrocarbonated resin and an oil, the plasticising content is the sum of the hydrocarbonated resin content in phr and the oil content in phr, for the calculation of the ratio described above.

Advantageously, the at least one plasticising agent of the rubber composition is selected from the group constituted by plasticising oils, high-temperature vitreous transition plasticising resins Tg, and their combinations.

The rubber composition described above, with all its embodiments, is, in particular, the constituent material of the high-contrast sidewall element, which is formed integrally with the sidewall and is constituted by a texture having a first brightness L*1 at least equal to 1 and at most equal to 15, any sidewall surface portion adjacent to the high-contrast sidewall element having a second brightness L*2 at least equal to L*1+5.

Advantageously, the high-contrast sidewall element is constituted by a texture having a first brightness L*1 at least equal to 4 and at most equal to 13.

Also advantageously, any sidewall surface portion adjacent to the high-contrast sidewall element has a second brightness L*2 at least equal to L*1+10, preferably at least equal to L*1+12.

Also advantageously, any sidewall surface portion adjacent to the high-contrast sidewall element has a second brightness L*2 of at least 18, preferably at least 22.

According to a first and a second preferred embodiment, the high-contrast sidewall element is constituted by a texture comprising projections, which stand out in relief with respect to a sidewall surface, in contact with the atmospheric air, and/or cavities, which are recessed with respect to the sidewall surface.

According to a first variant of the first preferred embodiment, the high-contrast sidewall element is constituted by a texture comprising projections in the form of strands.

According to a second variant of the first preferred embodiment, the high-contrast sidewall element is constituted by a texture comprising projections in the form of strips.

The texture of a high-contrast sidewall element, according to the first and second preferred embodiments, is usually created by moulding during the curing of the tire. The corresponding mould element, which is designed to produce the texture of the high-contrast sidewall element, is produced, by way of non-limiting example, by machining or by laser etching. The texture of a high-contrast sidewall element can also be produced, directly on the sidewall surface of the tire after curing, for example by laser etching. The texture is consequently constituted by the same material as that of the remainder of the sidewall.

The texture of the high-contrast sidewall elements, comprising projections in the form of strands or strips, makes it possible to absorb a large part of the incident rays of light, after one or more successive reflections off the walls of the projections. This makes it possible to give the texture a darker appearance, and consequently to improve its contrast, and therefore its visibility in relation to any adjacent sidewall surface portion. Moreover, this particular texture makes it possible to obtain an agreeable feel on the sidewall surface, of the “velvet” type. Finally, the texture used has an effect which is water repellent and slightly hydrophobic. In a particular embodiment, the texture can be positioned on a surface which is recessed in relation to the sidewall surface, such that it is encrusted in the sidewall, which has the advantage of protecting it, for example, against the wear caused by scraping of the sidewall surface against a pavement.

Similarly, the texture of the high-contrast sidewall elements, comprising cavities which are recessed in relation to the sidewall surface, makes it possible to absorb a large part of the incident rays of light, after one or more successive reflections on the walls of the cavities. This specific texture has the advantage of being recessed in relation to the sidewall surface, which makes it possible to ensure that the said texture lasts, by protecting it against the wear caused by scraping of the sidewall surface against a pavement. It also has the advantage of not disturbing the aerodynamic flow of the air, in the vicinity of the sidewall surface, when the tire is rolling.

The rubber composition described within the context of the present invention is illustrated by the following non-limiting examples.

In order to confirm the properties of the rubber composition according to the present invention, ten rubber compositions (C1, C2, C3, C4 and C5: examples according to the invention, T1 and T3: references, and T2, T4 and T5: comparative examples) were used. Each of the formulations of the rubber compositions is presented in tables 1 and 3 with the amount of the various ingredients expressed in phr.

Each rubber composition was produced as follows: the reinforcing filler, the elastomer matrix, the anti-ozone wax, the crumb rubber when present, the plasticising agent and the various other ingredients, with the exception of the curing system, were successively introduced into an internal mixer having an initial tank temperature of 60° C.; the internal mixer of “Banbury” type being filled to approximately 70% of its volume. The thermo-mechanical work (non-productive phase) was subsequently carried out in a single step lasting from 3 to 4 minutes, until a maximum “dropping” temperature of 165° C. was reached. The mixture thus obtained was recuperated and cooled, and then the curing agent (sulphur) and the curing accelerator (N-cyclohexyl-2-benzothiazolesulphenamide) of the cross-linking system were incorporated in an external mixer (homo-finisher) at a temperature of 30° C., everything being mixed (productive phase) for a time of more than 5 minutes and less than 12 minutes.

The rubber compositions thus obtained were then calendered in the form of sheets to measure their properties of resistance to ozone and to measure the blooming according to the protocols below.

The resistance to ozone was measured according to the method described hereinafter. After curing at 150° C. for 40 min in a bell press, then cooling to ambient temperature (23° C.) for one day and then drying at 77° C. in air for 28 days, 10 test specimens for each of the elastomer compositions to be tested were placed on a trapezium with different elongations ranging from 10% to 100% in stages of 10% elongation. The “B15” test specimens were obtained from an MFTR (known as Monsanto) sheet, the two beads of which located at the ends were used to retain the test specimen. The test specimens known as “B15” had the following dimensions: 78.5 mm*15 mm*1.5 mm. After exposure for 192 hours to a temperature of 38° C. and to an ozone content of 50 ppm (parts per hundred million), each facies was recorded as a function of the number and depth of the cracks. This subjective grading ranged from 0 to 5 (0: no cracks; 1 to 4: presence of increasingly large and deep cracks; 5: breaking of the test specimen). The average of the gradings of all of the deformations was used as the classification criterion. The lower the average, the better the performance of resistance to ozone.

The differences between the averages of the gradings of all of the deformations of each sample (T2 and C1 to C3) and the reference (T1) are presented in table 2.

Similarly, table 4 presents the differences between the averages of the gradings of all of the deformations of each sample (T4, T5, C4 and C5) and the reference (T3).

A negative value in tables 2 and 4 indicates an improvement in the performance of resistance to ozone compared with the reference T1 for table 2 and the reference T3 for table 4.

The “blooming” performance is measured as follows. After an operation of cutting the sheets of cured rubber compositions, test specimens with a thickness of 2.5 mm are dried at 70° C. in air for 12 h. They are subsequently dried at 40° C. in air for 4 weeks. After exiting from the stove and exposure to ambient temperature (23° C.) for 15 min, a mechanical stimulus is applied so as to reveal the blooming of the wax. In the present case, the mechanical stimulus consists of an operation of scraping the test specimen with a metal blade. The extent of the phenomenon of blooming (white colouration of the surface) is subsequently evaluated by means of a subjective scale of values which is representative of the final appearance of the samples. The values of this subjective scale respectively obtained for the tested samples can vary from 0 to 3 and correspond to the “blooming grading”. These values, ranging from 0 to 3, correspond to the following appearances of the samples:
0—No blooming. The scraped surface remains black.
1—Slight blooming.
2—Moderate blooming.
3—Full blooming. The scraped surface is white.

The lower the value of the scale, i.e. the lower the level of blooming, the more the performance in terms of blooming is good.

The differences between the blooming values of each sample (T2 and C1 to C3) and the reference (T1) are presented in table 2. Likewise, table 4 presents the differences between the blooming values of each sample (T4, T5, C4 and C5) and the reference (T3). A negative value in tables 2 and 4 indicates an improvement in blooming performance compared to each reference respectively (T1, T3).

In the example of test 1, a comparison is made of a rubber composition for a sidewall having a reference rubber composition (T1), not comprising crumb rubber, and compositions T2 (comparative) and C1 to C3 (according to the invention), as defined in table 1 below:

TABLE 1

| Composition | T1 | T2 | C1 | C2 | C3 |
|---|---|---|---|---|---|
| Isoprene elastomer (1) | 35 | 60 | 60 | 60 | 60 |
| Butadiene elastomer (2) | 65 | 40 | 40 | 40 | 40 |
| Reinforcing filler (3) | 50 | 32 | 32 | 32 | 32 |
| Crumb rubber (4) | (—) | (—) | 17 | (—) | (—) |
| Crumb rubber (5) | (—) | (—) | (—) | 17 | (—) |
| Crumb rubber (6) | (—) | (—) | (—) | (—) | 17 |
| Anti-ozone wax (7) | 2.0 | 2.0 | 2.3 | 2.3 | 2.3 |
| Liquid plasticising agent (8) | 17.5 | 10 | 10 | 10 | 2 |
| Plasticising resin (9) | (—) | (—) | (—) | (—) | 8 |
| Anti-oxidant (10) | 5.4 | 5.4 | 6.1 | 6.1 | 6.1 |
| Stearic acid (11) | 1.1 | 1.1 | 1.1 | 1.1 | 1.1 |
| Zinc oxide (12) | 2.5 | 2.5 | 2.5 | 2.5 | 2.5 |
| Curing accelerator (13) | 1.5 | 1.5 | 1.7 | 1.7 | 1.7 |
| Sulphur | 1.5 | 1.5 | 1.7 | 1.7 | 1.7 |

(1) Natural rubber;
(2) Cis-1,4 polybutadiene synthesised with a neodymium catalyst having a cis-1,4 bond content of at least 98 mol %;
(3) Carbon black of grade ASTM N550 according to the standard ASTM D1765-14, having an STSA measured according to the standard ASTM D6556-10 equal to 39 m²/g, a COAN index measured according to the standard ASTM D3493-16 equal to 85 ml/100 g;
(4) Crumb rubber obtained by recycling (tire micronisation), crumb rubber sold by Lehigh Technology, the percentage of microparticles of crumb measured according to the standard ASTM D5644-01 (2013) retained by a 400 μm screen is less than 1% by weight, and the percentage of particles of crumb retained by a 250 μm screen is less than 12% by weight in relation to the total weight of the crumb rubber particles, crumb rubber not modified;
(5) Crumb rubber obtained by recycling (tire micronisation), crumb rubber sold by Lehigh Technology, the percentage of microparticles of crumb measured according to the standard ASTM D5644-01 (2013) retained by a 250 μm screen is less than 1% by weight, and the percentage of particles of crumb retained by a 177 μm screen is less than 10% by weight in relation to the total weight of the crumb rubber particles, crumb rubber not modified;
(6) Crumb rubber obtained by recycling (tire micronisation), crumb rubber sold by Lehigh Technology, the percentage of microparticles of crumb measured according to the standard ASTM D5644-01 (2013) retained by a 600 μm screen is less than 1% by weight, and the percentage of particles of crumb retained by a 400 μm screen is less than 12% by weight in relation to the total weight of the crumb rubber particles, crumb rubber not modified;
(7) Anti-ozone wax sold by Sasol under the commercial reference “Varazon 4959”;
(8) TDAE oil sold by H&R under the commercial reference “VivaTec 500”;
(9) C5 plasticising hydrocarbonated resin sold by Exxon under the commercial reference “Escorez 1102”;
(10) Mixture of 2 anti-oxidants: ((N-(1,3-dimethylbutyl)-N-phenyl-para-phenylenediamine sold by Flexsys sous la reference “Santoflex 6-PPD” and 2,2,4-trimethyl-1,2-dihydroquinolone sold by Lanxess;
(11) Stearic acid sold by Uniquema under the reference “Pristerene 4931”;
(12) Zinc oxide: commercial quality, sold by Umicore;
(13) N-dicyclohexyl-2-benzothiazole sulphenamide, sold by Flexsys under the reference “Santocure CBS”.

The performances obtained are presented in table 2 below:

TABLE 2

| Composition | T1 | T2 | C1 | C2 | C3 |
|---|---|---|---|---|---|
| Ozone-resistance performance | 0 | −0.8 | −0.3 | −0.3 | −0.1 |
| Blooming performance | 0 | 0 | −2 | −2 | −2 |

The results in Table 2 show that only the rubber compositions C1, C2 and C3 according to the invention simultaneously have better blooming performance and better performance of resistance to ozone in relation respectively to the reference rubber composition (T1) and to the rubber composition of the comparative example (T2).

In the example of test 2, a comparison is made of a rubber composition for a sidewall comprising a reference rubber composition (T3), not comprising crumb rubber, and (comparative) compositions T4 and T5, and C4 to C5 (according to the invention), as defined in table 3 below:

TABLE 3

| Composition | T3 | T4 | T5 | C4 | C5 |
|---|---|---|---|---|---|
| Isoprene elastomer (1) | 53 | 53 | 53 | 53 | 53 |
| Butadiene elastomer (2) | 47 | 47 | 47 | 47 | 47 |
| Reinforcing filler (3) | 29 | 29 | 29 | 29 | 29 |
| Crumb rubber (4) | (—) | (—) | (—) | (—) | (—) |
| Crumb rubber (5) | (—) | 17 | 17 | 17 | (—) |
| Crumb rubber (6) | (—) | (—) | (—) | (—) | 17 |
| Anti-ozone wax (7) | 2.0 | 1.0 | 3.1 | 2.3 | 2.3 |
| Liquid plasticising agent (8) | 12 | 12 | 12 | 12 | 12 |
| Plasticising resin (9) | (—) | (—) | (—) | (—) | (—) |
| Anti-oxidant (10) | 5.7 | 5.7 | 5.7 | 5.7 | 5.7 |
| Stearic acid (11) | 1.1 | 1.1 | 1.1 | 1.1 | 1.1 |
| Zinc oxide (12) | 2.5 | 2.5 | 2.5 | 2.5 | 2.5 |
| Curing accelerator (13) | 1.7 | 1.7 | 1.7 | 1.7 | 1.7 |
| Sulphur (14) | 1.7 | 1.7 | 1.7 | 1.7 | 1.7 |

The ingredients in table 3 are the same as those listed in table 1.

The performances obtained are presented in table 4 below:

TABLE 4

| Composition | T3 | T4 | T5 | C4 | C5 |
|---|---|---|---|---|---|
| Ozone-resistance performance | 0 | +0.4 | −0.9 | −0.6 | −0.1 |
| Blooming performance | 0 | −2 | 0 | −2 | −2 |

The results in table 4 also show that the examples (C4 and C5) according to the invention simultaneously have better blooming performance and better performance of resistance to ozone than the reference elastomer composition (T3) and than the comparative rubber compositions (T4 and T5).

In conclusion, the rubber composition according to the invention makes it possible to obtain a sidewall with a good compromise of properties of blooming performance and performance of resistance to ozone, which makes it possible to obtain a long-lasting high-contrast sidewall element, throughout the life of the tire.

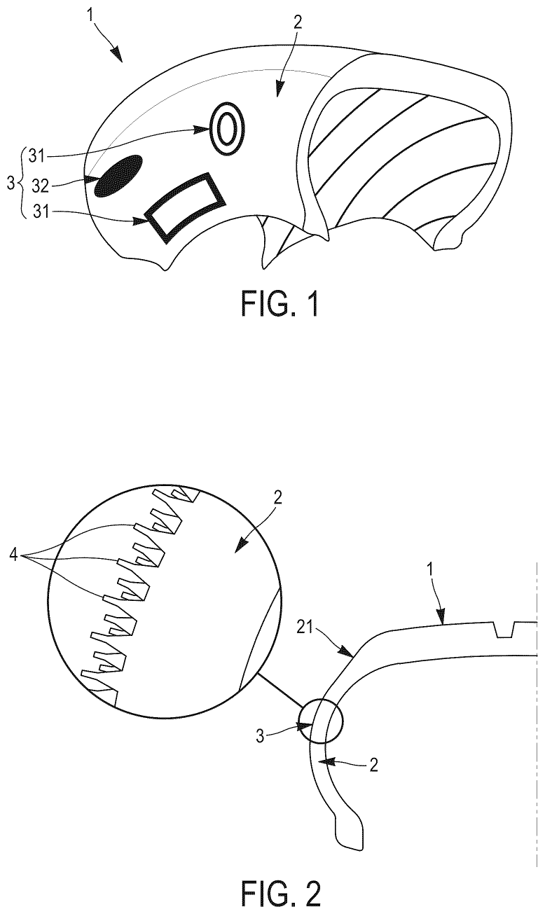

The features of a high-contrast sidewall element according to the invention are illustrated by FIGS. 1 to 5, which are schematic and not represented to scale:

FIG. 1: View in perspective of a portion of tire comprising a sidewall with high-contrast elements;

FIG. 2: Meridian half-cross-section of a tire comprising a sidewall with a high-contrast element;

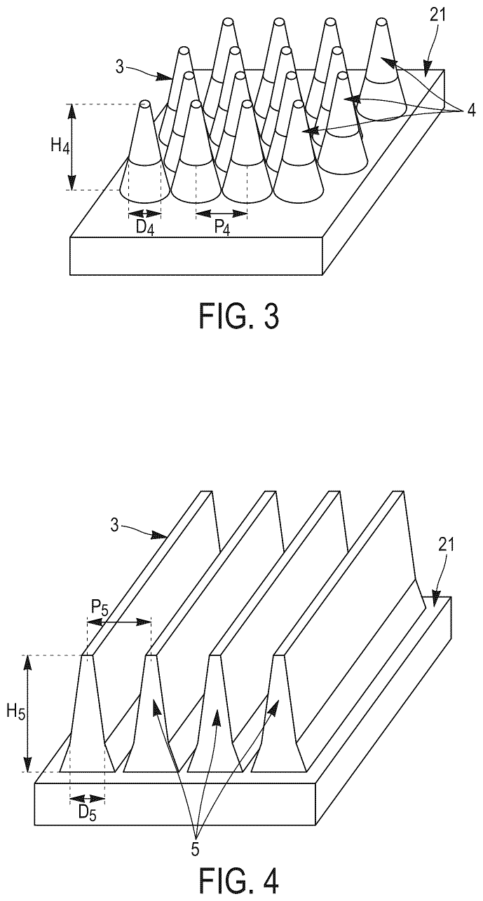

FIG. 3: Texture of a high-contrast element comprising projections in the form of strands, according to a first variant of the first preferred embodiment of the texture;

FIG. 4: Texture of a high-contrast element comprising projections in the form of strips, according to a second variant of the first preferred embodiment of the texture;

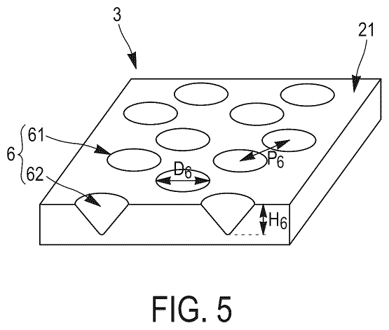

FIG. 5: Texture of a high-contrast element comprising cavities, according to the second preferred embodiment of the texture.

FIG. 1 is a view in perspective of a portion of tire 1 comprising a sidewall 2 with high-contrast elements 3. The high-contrast elements 3 represented include two graphical elements 31, which are designed to communicate technical, commercial or legal information, and an aesthetic element 32.

FIG. 2 is a meridian half-cross-section of a tire 1 comprising a sidewall 2 with a high-contrast element 3 constituted by a texture comprising projections 3 which are in relief in relation to the surface of the sidewall 21. The projections 4 have the form of strands as represented in FIG. 3.

FIG. 3 is a texture of a high-contrast element 3 comprising projections in the form of strands 4, according to a first variant of the first preferred embodiment of the texture. The projections in the form of strands 4, which stand out in relief with respect to a sidewall surface, have an average height H₄. The average height is understood to be the arithmetic mean of the heights of all of the projections. The projections in the form of strands 4 are spaced apart by an average spacing P₄. The projections in the form of strands 4, which have a diameter that varies over the entire height of the strand, have an average diameter D₄. In the embodiment represented, the projections in the form of strands 4 have a diameter that reduces from a strand base, interfacing with the sidewall surface, and a free strand apex.

FIG. 4 is a texture of a high-contrast element 3 comprising projections in the form of strips 5, according to a second variant of the first preferred embodiment of the texture. The projections in the form of strips 5, which stand out in relief with respect to a sidewall surface, have an average height H₅. The average height is understood to be the arithmetic mean of the heights of all of the projections. The projections in the form of strips 5 are spaced apart by a spacing P₅. The projections in the form of strips 5, which have a width that varies over the entire height of the strip, have an average width D₅. In the embodiment represented, the projections in the form of strips 5 have a width that reduces from a strip base, interfacing with the sidewall surface, and a free strip apex.

FIG. 5 is a texture of a high-contrast element 3 comprising cavities 6, according to the second preferred embodiment of the texture. The cavities 6, which are recessed with respect to a sidewall surface, have an average depth. “Average depth” means the arithmetic average of the depths of all of the cavities. A cavity 6 is constituted by a cavity interior 62, formed in the thickness of the sidewall, and an opening 61, which opens into the surface of the sidewall. The openings 61 onto the sidewall surface are spaced apart by a spacing P₆. The openings 61 onto the sidewall surface have an average diameter D₆. Average diameter means an arithmetic average of the diameters, which are not necessarily identical, of the openings on the sidewall surface.

1. A tire for a vehicle, comprising a sidewall with at least one high-contrast sidewall element:
the high-contrast sidewall element being constituted by a texture having a first brightness L*1 at least equal to 1 and at most equal to 15,
any sidewall surface portion adjacent to the high-contrast sidewall element having a second brightness L*2 at least equal to L*1+5,
the first and second brightnesses (L*1, L*2) being expressed on a scale ranging from 0 to 100 in accordance with the L*a*b colour model adopted in 1976 by the International Commission on Illumination,
the sidewall comprising a rubber composition based on an elastomer matrix, at least one reinforcing filler, at least one cross-linking system, at least one plasticising agent, at least one anti-ozone wax, and at least one crumb rubber,
wherein the elastomer matrix comprises an isoprene elastomer with a content of at least 35 phr, and at the most 65 phr and a butadiene elastomer with a content of at least 35 phr, and at the most 65 phr, the content of reinforcing filler is at least 5 phr, and at the most 70 phr, the content of anti-ozone wax is at least 1.2 phr, and at the most 2.8 phr, and wherein the content of crumb rubber is at least 2 phr, and at the most 30 phr.

2. The tire according to claim 1, wherein the content of anti-ozone wax is at least 1.4 phr, and at the most 2.6 phr, and preferably at least 1.6 phr, and at the most 2.4 phr.

3. The tire according to claim 1, wherein the content of crumb rubber is at least 5 phr, and at the most 20 phr, preferably at least 5.5 phr, and at the most 19.5 phr, more preferably at least 6 phr, and at the most 19 phr, and still more preferably at least 6 phr, and at the most 18 phr.

4. The tire according to claim 1, wherein the ratio between the content of crumb rubber, expressed in phr, and the content of anti-ozone wax, expressed in phr, is at least 5.50, and at the most 17.00, preferably at least 6.00, and at the most 17.00, and more preferably at least 6.50, and at the most 12.50.

5. The tire according claim 1, wherein the content of reinforcing filler is at least 10 phr, and at the most 60 phr, preferably at least 15 phr, and at the most 55 phr, more preferably at least 15 phr, and at the most 50 phr, and still more preferably at least 15 phr, and at the most 45 phr.

6. The tire according to claim 1, wherein the sum of the content of reinforcing filler and of the content of crumb rubber is at least 30 phr, and at the most 65 phr, preferably at least 30 phr, and at the most 60 phr, and more preferably at least 35 phr, and at the most 50 phr.

7. The tire according to claim 1, wherein the reinforcing filler predominantly comprises carbon black.

8. The tire according to claim 1, wherein the ratio between the content of reinforcing filler, expressed in phr, and the content of plasticising agent, expressed in phr, is at least 1.00, and at the most 5.00, preferably at least 1.50, and at the most 4.50, more preferably at least 2.00, and at the most 4.00, and even more preferably at least 2.00, and at the most 3.50.

9. The tire according to claim 1, wherein the high-contrast sidewall element is constituted by a texture having a first brightness L*1 at least equal to 4 and at most equal to 13.

10. The tire according to claim 1, wherein any sidewall surface portion adjacent to the high-contrast sidewall element has a second brightness L*2 at least equal to L*1+10, preferably at least equal to L*1+12.

11. The tire according to claim 1, wherein any sidewall surface portion adjacent to the high-contrast sidewall element has a second brightness L*2 at least equal to 18, preferably at least equal to 22.

12. The tire according to claim 1, wherein the high-contrast sidewall element is constituted by a texture comprising projections, which stand out in relief with respect to a sidewall surface, in contact with the atmospheric air, and/or cavities, which are recessed with respect to the sidewall surface.

13. The tire according to claim 1, wherein the high-contrast sidewall element is constituted by a texture comprising projections in the form of strands.

14. The tire according to claim 1, wherein the high-contrast sidewall element is constituted by a texture comprising projections in the form of strips.
